(19) United States
(12) Patent Application Publication
(10) Pub. No.: US 2026/0203041 A1
(43) Pub. Date: Jul. 16, 2026

(54) SOFTWARE UPDATE SYSTEM, SOFTWARE UPDATE DEVICE, SOFTWARE UPDATE METHOD, AND STORAGE MEDIUM

(71) Applicant: HONDA MOTOR CO., LTD., TOKYO (JP)

(72) Inventors: Yasumasa KAITANI, TOKYO (JP); Yujiro KOMIYAMA, TOKYO (JP); Yutaro YASUDA, TOKYO (JP); Kazuki UNNO, TOKYO (JP); Yuki OKABE, TOKYO (JP)

(21) Appl. No.: 19/446,244

(22) Filed: Jan. 12, 2026

(30) Foreign Application Priority Data
Jan. 14, 2025 (JP) 2025-004607

(51) Int. Cl. G06F 8/65; H04L 67/00

(52) U.S. Cl. CPC G06F 8/65; H04L 67/34

(57) ABSTRACT

In a software update system, an ON-control prohibition unit continuously prohibits ON-control until an activation process is completed, in a state where an electronic control unit equipped with an update control unit is the target of a software update process and the activation process of the software update process is being executed for the electronic control unit equipped with the update control unit.

### CROSS-REFERENCE TO RELATED APPLICATIONS

This application is based upon and claims the benefit of priority from Japanese Patent Application No. 2025-004607 filed on Jan. 14, 2025, the contents of which are incorporated herein by reference.

### BACKGROUND OF THE INVENTION

### Field of the Invention

The present disclosure relates to a software update system, a software update device, a software update method, and a storage medium.

### Description of the Related Art

JP 2009-102003 A discloses a software update technique capable of updating software at a timing that does not affect the traveling or the like of a vehicle.

### SUMMARY OF THE INVENTION

It is desirable to update software in a preferable manner.

The present disclosure aims to solve the aforementioned problems.

A first aspect of the present disclosure is a software update system comprising a vehicle and a server device capable of communicating with the vehicle via a network, wherein the software update system comprises an update control unit that executes software update processing, which is a process for updating software, for an electronic control unit provided in the vehicle, and an ON-control prohibition unit configured to prohibit ON-control, which is control for switching the vehicle from a non-drivable state to a drivable state in response to a user's operation of turning on a switch, and in a state where the electronic control unit provided with the update control unit is a target of the software update process and the activation process of the software update process is being executed for the electronic control unit equipped with the update control unit, the ON-control prohibition unit continues to prohibit the ON-control until the activation process is completed.

A second aspect of the present disclosure is a software update device comprising: an update control unit configured to execute a software update process for an electronic control unit provided in a vehicle; and an ON-control prohibition unit configured to prohibit ON-control, which is control for switching the vehicle from a non-drivable state to a drivable state in response to an operation of turning on a switch by a user, wherein in a state where the electronic control unit provided with the update control unit is a target of the software update process and the activation process of the software update process is being executed for the electronic control unit provided with the update control unit, the ON-control prohibition unit continues to prohibit the ON-control until the activation process is completed.

A third aspect of the present disclosure is a software update method comprising: an update control step of executing a software update process for an electronic control unit provided in a vehicle; and an ON-control prohibition step of prohibiting ON-control, which is control for switching the vehicle from a non-drivable state to a drivable state in response to an operation of turning on a switch by a user, wherein in a state where the electronic control unit that executes the software update process is a target of the software update process and an activation process of the software update process is being executed for the electronic control unit that executes the software update process, the ON-control prohibition step continues to prohibit the ON-control until the activation process is completed.

A fourth aspect of the present disclosure is a program that causes a computer to execute the software update method of the third aspect.

According to the present disclosure, software update can be performed favorably.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram illustrating a software update system;

FIG. 2 is a flowchart of the software update process performed by the software update system;

FIG. 3 is a flowchart of the software update process performed by a software update device; and

FIG. 4 is a time chart of a software update process.

### DETAILED DESCRIPTION OF THE INVENTION

Conventionally, software update for a vehicle-mounted electronic control unit (ECU) was performed at a dealer or the like. Recently, vehicles capable of updating ECU software over the air (OTA) using wireless communication have been commercially available. Such vehicles can update ECU software without being brought to a dealer or the like.

Software update is performed by an ECU dedicated to software update (referred to as software update device). The software update device executes a software update process in the order of download process, installation process, activation process, and completion process. The software update device performs the download process and the installation process when a vehicle operates. The software update device also starts the activation process in accordance with the user's operation of a stop switch of the vehicle (IG-OFF operation). When the activation process starts, the operation of an activation switch (IG-ON operation) of the vehicle by the user is prohibited.

When the software update device is a target of software update, the software update device restarts in the middle of the activation process and then shuts down when the activation process ends. If the prohibition of the IG-ON operation is revoked immediately after the restart, the IG-ON operation becomes possible with the activation process being incomplete. If the IG-ON operation is performed immediately after the restart of the software update device, the activation process ends and the completion process starts several seconds or minutes after the IG-ON operation. In this case, the user cannot be notified of the completion of the software update immediately after the IG-ON operation. In contrast, according to the present disclosure described below, the user can be notified, immediately after the IG-ON operation, that the software update has been completed.

### 1 Configuration of Software Update System 10

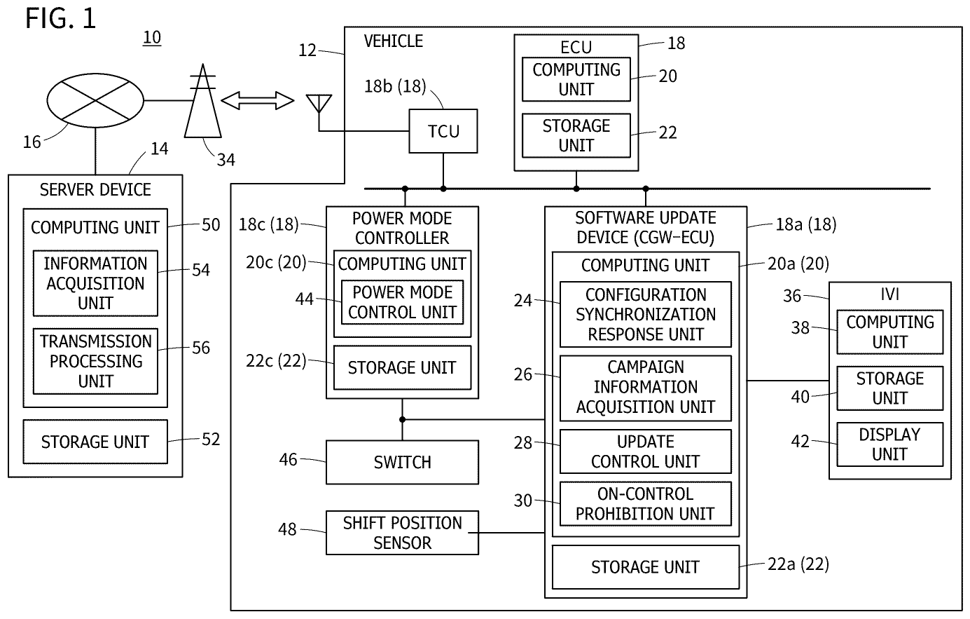

FIG. 1 is a schematic diagram illustrating a software update system 10. The software updating system 10 includes a vehicle 12 and a server device 14. The server device 14 is capable of communicating with the vehicle 12 via a network 16.

The vehicle 12 is equipped with a plurality of ECUs 18. Each ECU 18 performs control to implement a traveling function and other functions of the vehicle 12. Each ECU 18 has a computing unit 20 and a storage unit 22. The computing unit 20 is a processor such as a CPU (Central Processing Unit), a GPU (Graphics Processing Unit), or the like. At least part of the computing unit 20 may be realized by an integrated circuit such as an ASIC (Application Specific Integrated Circuit), an FPGA (Field-Programmable Gate Array), or the like. At least part of the computing unit 20 may be realized by an electronic circuit including discrete devices.

The storage unit 22 is a computer-readable, non-transitory tangible storage medium. The storage unit 22 is composed of a volatile memory (not shown) and a non-volatile memory (not shown). The volatile memory is, for example, RAM (Random Access Memory) or the like. The non-volatile memory is, for example, ROM (Read Only Memory), flash memory, or the like. Data or the like are stored, for example, in the volatile memory. Programs, tables, maps, or the like are stored, for example, in the non-volatile memory. At least part of the storage unit 22 may be provided in the above-mentioned processor, integrated circuit, or the like. At least part of the storage unit 22 may be mounted in a device connected to the vehicle 12 via the network 16.

Each ECU 18 is connected to a CAN (Controller Area Network) (registered trademark in Japan). Each ECU 18 can communicate with each other via the CAN. A communication line to which each ECU 18 is connected is not limited to the CAN, and Ethernet (registered trademark in Japan) may be used, or both CAN and Ethernet may be used. Furthermore, as the communication line, a communication line according to other standards than CAN and Ethernet may be used.

The ECUs 18 include a software update device 18a, a telematics control unit (hereinafter, “TCU”) 18b, and a power mode controller 18c.

The software update device 18a may be constituted by, for example, a CGW-ECU (Central GateWay-Electronic Control Unit). The software update device 18a has a computing unit 20a and a storage unit 22a. The computing unit 20a has a configuration synchronization response unit 24, a campaign information acquisition unit 26, an update control unit 28, and an ON-control prohibition unit 30. The configuration synchronization response unit 24, the campaign information acquisition unit 26, the update control unit 28, and the ON-control prohibition unit 30 are realized by the computing unit 20a executing programs stored in the storage unit 22a. At least part of the configuration synchronization response unit 24, the campaign information acquisition unit 26, the update control unit 28, and the ON-control prohibition unit 30 may be realized by an integrated circuit such as an ASIC or an FPGA. At least part of the configuration synchronization response unit 24, the campaign information acquisition unit 26, the update control unit 28, and the ON-control prohibition unit 30 may be realized by an electronic circuit including discrete devices.

The software update device 18a performs the software update process for the ECU 18 (including the software update device 18a). The software update process includes a software download process, a software installation process, a software activation process, and a completion process.

The software downloading process includes a process of acquiring the update data transmitted from the server device 14 via the network 16 and storing the update data in the storage unit 22a of the software update device 18a. The update data is data including a program or the like of the updated software. The update data may include an installer or the like.

The software installation process includes a process of loading the update data of the storage unit 22a into the ROM of the ECU 18. The software installation process may be performed by an installer. The software installation process may be performed by copying the update data to the ROM.

The software activation process includes a process of authenticating the license of installed software. During the activation process of software, executable files and so on used by the prior-to-updating software may be rewritten. Upon completion of the software activation process, the execution of the software is allowed in the ECU 18. The activation process may be performed by the software update device 18a or by another ECU 18.

The completion process involves post-processing of the software update. For example, the completion process includes a process of uploading a result log to the server device 14 and a process of notifying the user that the software update has been completed. The result log includes information on whether the software of the ECU 18 has been successfully updated, information on the time when the activation process has ended, and the like.

The configuration synchronization response unit 24 transmits configuration synchronization information to the server device 14 in response to a configuration synchronization request transmitted from the server device 14. (Note that the software update device 18a may transmit the configuration synchronization request to the server device 14.) The campaign information acquisition unit 26 acquires campaign information, which is information related to the software update process, from the server device 14, and stores the campaign information in the storage unit 22a. The update control unit 28 executes the software update process for the ECU 18 that includes the software to be updated. The ON-control prohibition unit 30 prohibits ON-control, which is control for switching the vehicle 12 from a non-drivable state to a drivable state, during the activation process of the software update process.

The software update device 18a is capable of communicating with the base station 34 connected to the network 16 by means of cellular communication via the TCU 18b. The network 16 is, for example, the Internet.

An in-vehicle infotainment (hereafter, “IVI”) 36 is connected to the software update device 18a. The IVI 36 has a computing unit 38 and a storage unit 40. The computing unit 38, for example, is a processor such as a CPU, a GPU, or the like.

The storage unit 40 is a computer readable non-transitory tangible storage medium. The storage unit 40 is constituted by a non-illustrated volatile memory and a non-illustrated non-volatile memory. The volatile memory is, for example, RAM or the like. The non-volatile memory is, for example, ROM, flash memory, or the like. Data or the like are stored, for example, in the volatile memory. Programs, tables, maps, or the like are stored, for example, in the non-volatile memory. At least part of the storage unit 40 may be provided in the above-mentioned processor, integrated circuit, or the like. At least part of the storage unit 40 may be mounted in a device connected to the vehicle 12 via the network 16.

The IVI 36 provides information such as display of road traffic information and route guidance and also provides entertainment through audio, DVD, TV tuner, and so on.

The IVI 36 has a display unit 42. The display unit 42 is installed on a dashboard or the like of the vehicle 12. The display unit 42 is a touch panel display. The display unit 42 provides the user with information in the form of images, characters, and so on and accepts operation input performed by the user. The screen of the display unit 42 is not particularly limited and may be a liquid crystal, organic electroluminescence (organic EL), or the like. The touch panel of the display unit 42 is not particularly limited and may be a resistive film type, a capacitance type, or the like. Instead of the display unit 42 being a touch panel display, a combination of a display device such as a heads-up display and a pointing device such as a motion capture device may be used.

The power mode controller 18c has a computing unit 20c and a storage unit 22c. The computing unit 20c has a power mode control unit 44. The power mode control unit 44 is realized by the computing unit 20c executing programs stored in the storage unit 22c. The power mode control unit 44 may be realized by an integrated circuit such as an ASIC or an FPGA. The power mode control 44 may be realized by an electronic circuit including discrete devices.

The power mode control unit 44 switches the power mode of the vehicle 12 in response to the operation of the start/stop switch (hereinafter, “switch”) 46 by the user. When the vehicle 12 is an engine vehicle, the power modes include an OFF mode, an ACC mode, an ON mode, and a START mode. When the vehicle 12 is a hybrid vehicle or an electric vehicle, the power modes include an OFF mode, an ACC mode, and a READY mode.

The OFF mode is a state in which the power supply of the vehicle 12 is OFF. In the OFF mode, most of the equipment of the vehicle 12 cannot be used. Even in the OFF mode, a keyless entry system and the like can be used. The state of the switch 46 in the OFF mode may be referred to as IG-OFF or ACC-OFF. In the ACC mode, devices such as an audio device can be used. The state of the switch 46 in the ACC mode may be referred to as IG-OFF or ACC-ON. In the ON mode, all the equipment of the vehicle 12 can be used. The state of the switch 46 in the ON mode may be referred to as IG-ON. The START mode is a state in which the engine starts, and the vehicle 12 can travel after the engine starts. The READY mode is a state in which the vehicle 12 can travel by means of the drive motor. The state of the switch 46 in the READY mode may be referred to as READY.

If the vehicle 12 is an engine vehicle, the power mode control unit 44 can control the start and stop of the engine. For example, the power mode control unit 44 outputs a start signal to the engine ECU (ECU 18) when detecting that the state of the switch 46 has been switched from any of the OFF mode, the ACC mode, and the ON mode to the START mode. Accordingly, the engine ECU starts the engine. For example, the power mode control unit 44 outputs a stop signal to the engine ECU when detecting that the state of the switch 46 has been switched from the ON mode to either the OFF mode or the ACC mode after the start of the engine. Accordingly, the engine ECU stops the engine.

If the vehicle 12 is a hybrid or electric vehicle, the power mode control unit 44 can control the start and stop of the motor system. For example, the power mode control unit 44 outputs a start signal to the motor ECU (ECU 18) when detecting that the state of the switch 46 has been switched from either the OFF mode or the ACC mode to the READY mode. For example, the power mode control unit 44 outputs a stop signal to the motor ECU when detecting that the state of the switch 46 has been switched from the READY mode to either the OFF mode or the ACC mode.

In this specification, the output of the start signal by the power mode control unit 44 to the engine ECU or the motor ECU is referred to as ON-control. In this specification, the output of the stop signal by the power mode control unit 44 to the engine ECU or the motor ECU is referred to as OFF-control. That is, the power mode control unit 44 executes the ON-control, which is control for switching the vehicle 12 from the non-drivable state to the drivable state, and the OFF-control, which is control for switching the vehicle 12 from the drivable state to the non-drivable state.

The vehicle 12 is equipped with a shift position sensor 48. The shift position sensor 48 detects a shift position selected as a result of a user operation.

The server device 14 has a computing unit 50 and a storage unit 52. The computing unit 50, for example, is a processor such as a CPU, a GPU, or the like. The computing unit 50 includes an information acquisition unit 54 and a transmission processing unit 56. The information acquisition unit 54 and the transmission processing unit 56 are realized by the computing unit 50 executing programs stored in the storage unit 52. At least part of the information acquisition unit 54 and the transmission processing unit 56 may be realized by an integrated circuit such as an ASIC or an FPGA. At least part of the information acquisition unit 54 and the transmission processing unit 56 may be realized by an electronic circuit including discrete devices.

The storage unit 52 is a computer-readable, non-transitory tangible storage medium. The storage unit 52 is composed of a volatile memory (not shown) and a non-volatile memory (not shown). The volatile memory is, for example, RAM or the like. The non-volatile memory is, for example, ROM, flash memory, or the like. Data or the like are stored, for example, in the volatile memory. Programs, tables, maps, or the like are stored, for example, in the non-volatile memory. At least part of the storage unit 52 may be provided in the above-mentioned processor, integrated circuit, or the like. At least part of the storage unit 52 may be mounted in a device connected to the server device 14 via the network 16.

A plurality of vehicles 12 are registered in the server device 14, and the update status of the software of the ECU 18 of each vehicle 12 is managed. The server device 14 provides each vehicle 12 with the update data for updating the software of the ECU 18 of each vehicle 12.

### 2 Software Update Process Performed by Software Update System 10

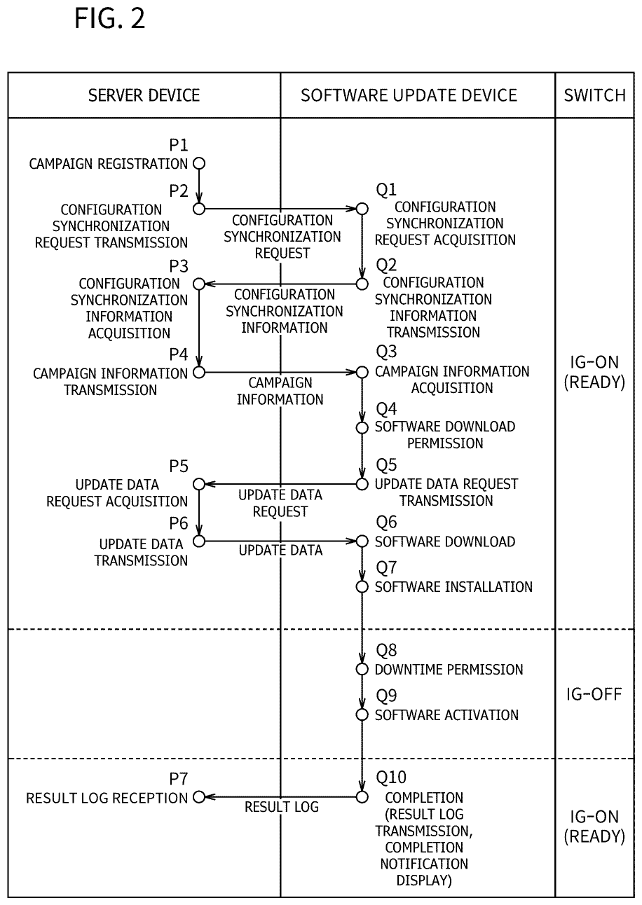

FIG. 2 is a flowchart of the software update process performed by the software update system 10. The software update process performed by the software update system 10 will be outlined with reference to FIG. 2.

After the campaign information is registered in the server device 14 (P1), the vehicle 12 performs a command request for the server device 14. If there is a campaign registered in the server device 14, the transmission processing unit 56 transmits a configuration synchronization request to the software update device 18a of the vehicle 12 (P2). The campaign information, together with the update data for updating the software of the ECU 18, is registered in the server device 14 by a software developer of the ECU 18, a manufacturer of the vehicle 12, and so on.

The configuration synchronization response unit 24 of the software update device 18a, upon acquiring the configuration synchronization request (Q1), transmits the configuration synchronization information to the server device 14 (Q2). The configuration synchronization information includes information on a unique identifier assigned to each ECU 18 of the vehicle 12, information on a version of the software of each ECU 18, and the like.

The configuration synchronization response unit 24 transmits the configuration synchronization information to the server device 14 not only when obtaining the configuration synchronization request transmitted from the server device 14 as described above. For example, when the configuration synchronization is instructed by the user via the IVI 36 or the like, the configuration synchronization response unit 24 may transmit the configuration synchronization information to the server device 14. Further, the configuration synchronization response unit 24 may periodically transmit the configuration synchronization information to the server device 14.

When the information acquisition unit 54 of the server device 14 acquires the configuration synchronization information (P3), the transmission processing unit 56 transmits to the software update device 18a the campaign information related to the software update process for each ECU 18 (P4).

The campaign information acquisition unit 26 of the software update device 18a acquires the campaign information (Q3) and stores the campaign information in the storage unit 22a. The update control unit 28 causes the display unit 42 of the IVI 36 to display the campaign information. A confirmation process for confirming with the user whether to permit the software download is performed by the update control unit 28. In this confirmation process, when the user permits the software download (Q4), the update control unit 28 transmits an update data request to the server device 14 (Q5).

When the information acquisition unit 54 of the server device 14 acquires the update data request (P5), the transmission processing unit 56 transmits the update data to the software update device 18a (P6).

The update control unit 28 of the software update device 18a executes the software download process. That is, the update control unit 28 acquires the update data and stores the update data in the storage unit 22a, thereby downloading the software (Q6). Then, the update control unit 28 executes the software installation process. That is, the update control unit 28 loads the update data of the storage unit 22a into the ROM of the ECU 18 and installs the software (Q7).

When the state of the switch 46 is switched from IG-ON (or READY) to IG-OFF and the shift position detected by the shift position sensor 48 is “P”, the update control unit 28 performs a confirmation process for confirming with the user whether to permit the downtime. In this confirmation process, when the user permits the downtime (Q8), the update control unit 28 executes a software activation process for the ECU 18 (Q9). The downtime indicates a time period during which the power mode control unit 44 cannot set the power mode of the vehicle 12 to the START mode or the READY mode and the vehicle 12 cannot start traveling while the software activation process is in progress. Upon completion of the software activation process, the power mode control unit 44 can set the power mode of the vehicle 12 to the START mode or the READY mode.

When the software activation process is completed and the state of the switch 46 is switched from IG-OFF to IG-ON (or READY), the update control unit 28 executes the completion process (Q10). For example, the update control unit 28 uploads the result log to the server device 14. The result log includes information on whether the software of the ECU 18 has been successfully updated, the time when the activation is completed, and the like. The update control unit 28 also causes the display unit 42 of the IVI 36 to display a completion notification indicating that the software update has been completed.

When the information acquisition unit 54 of the server device 14 acquires the result log (P7), the software update ends.

### 3 Software Update Process Performed by Software Update Device 18a

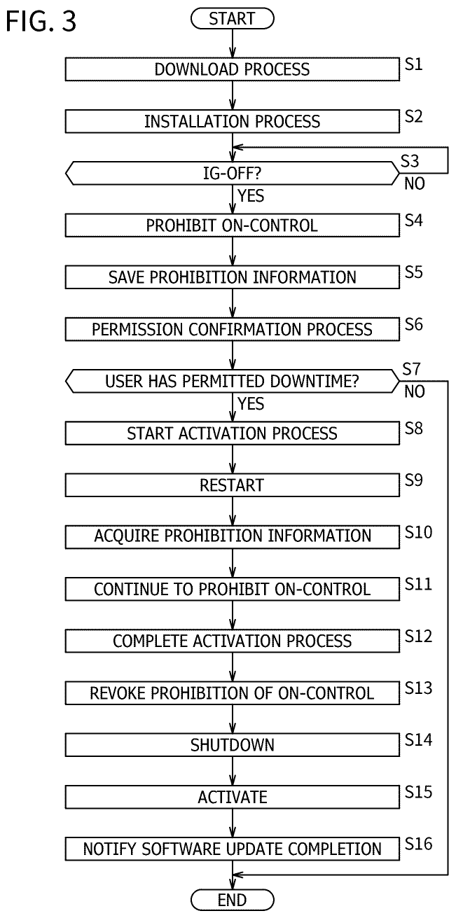

FIG. 3 is a flowchart of the software update process performed by the software update device 18a. FIG. 3 shows the details of the process performed by the software update device 18a from the software download (Q6) to completion (Q10) shown in FIG. 2.

In step S1, the update control unit 28 executes the software download process. The download process is performed when the power mode of the vehicle 12 is IG-ON (or READY). The process of step S1 corresponds to the process of Q6 shown in FIG. 2. When the download process is finished, the process proceeds to step S2.

In step S2, the update control unit 28 executes the installation process of installing the downloaded software. The installation process is performed when the power mode of the vehicle 12 is IG-ON (or READY). The process of step S2 corresponds to the process of Q7 shown in FIG. 2. When the installation process ends, the process proceeds to step S3.

In step S3, the update control unit 28 determines whether the power mode of the vehicle 12 is IG-OFF. For example, the update control unit 28 acquires switch information indicating the state of the switch 46 from the power mode controller 18c. The update control unit 28 determines the power mode of the vehicle 12 based on the acquired switch information. If the power mode of the vehicle 12 is switched from IG-ON (or READY) to IG-OFF (step S3: YES), the process proceeds to step S4. On the other hand, if the power mode of the vehicle 12 is maintained at IG-ON (or READY) (step S3: NO), the process of step S3 is executed again.

When the process proceeds from step S3 to step S4, the ON-control prohibition unit 30 prohibits the ON-control. For example, the ON-control prohibition unit 30 outputs to the power mode controller 18c a prohibition instruction signal indicating that the ON-control is prohibited. The ON-control prohibition unit 30 continues to output the prohibition instruction signal periodically or continuously until the prohibition is revoked. In response to this prohibition instruction signal, the power mode control unit 44 of the power mode controller 18c does not perform the ON-control even if the state of the switch 46 is switched to the START mode or the READY mode.

In step S5, the ON control prohibition unit 30 saves prohibition information indicating the prohibition of the ON-control into the non-volatile memory of the storage unit 22a. Thus, the non-volatile memory of the storage unit 22a stores the prohibition information. The execution order of the process of step S4 and the process of step S5 is not fixed. The process of step S4 and the process of step S5 may be performed simultaneously.

In step S6, the update control unit 28 performs a process of confirming with the user whether to permit the downtime (permission confirmation process). The process of step S6 corresponds to the process of Q8 shown in FIG. 2. The update control unit 28 causes the display unit 42 of the IVI 36 to display a permission confirmation screen. As a result of the user performing a predetermined operation on the touch panel of the display unit 42, the update control unit 28 acquires permission information indicating whether the user has permitted the downtime. When the update control unit 28 acquires the permission information, the process proceeds to step S7.

In step S7, the update control unit 28 determines whether the user has permitted the downtime based on the acquired permission information. If the user has permitted the downtime (step S7: YES), the process proceeds to step S8. On the other hand, if the user does not permit the downtime (step S7: NO), the update control unit 28 executes shutdown of the software update device 18a and ends the series of processes shown in FIG. 3. If the user does not permit the downtime, the update control unit 28 suspends or aborts the software update process.

When the process proceeds from step S7 to step S8, the update control unit 28 starts the activation process. The process of step S8 corresponds to the process of Q9 shown in FIG. 2. When the activation process starts, the process proceeds to step S9.

In step S9, the update control unit 28 executes the restart of the software update device 18a that is necessary for the activation process. When the restart of the software update device 18a is executed, the process proceeds to step S10.

In step S10, the ON-control prohibition unit 30 acquires prohibition information from the non-volatile memory of the storage unit 22a immediately after the restart of the software update device 18a. When the ON-control prohibition unit 30 acquires the prohibition information, the process proceeds to step S11.

In step S11, the ON-control prohibition unit 30 continues to prohibit the ON-control. For example, the ON-control prohibition unit 30 resumes the output of the prohibition instruction signal to the power mode controller 18c, based on the acquired prohibition information. In response to this prohibition instruction signal, the power mode control unit 44 of the power mode controller 18c does not perform the ON-control even if the state of the switch 46 is switched to the START mode or the READY mode. In this way, the ON-control prohibition unit 30 maintains the prohibited state of the ON-control even after the restart of the software update device 18a, based on the prohibition information stored in the non-volatile memory of the storage unit 22a.

In step S12, the update control unit 28 completes the activation process. When the activation process ends, the process proceeds to step S13.

In step S13, the ON-control prohibition unit 30 revokes the prohibition of the ON-control. For example, the ON-control prohibition unit 30 stops the output of the prohibition instruction signal to the power mode controller 18c. The ON-control prohibition unit 30 deletes prohibition information stored in the non-volatile memory of the storage unit 22a. When the prohibition of the ON-control is revoked, the process proceeds to step S14.

In step S14, the update control unit 28 executes shutdown of the software update device 18a. Thus, the software update device 18a is turned off.

In step S15, the user operates the switch 46 to switch the state of the switch 46 to the START mode or the READY mode. In response to the user's operation of the switch 46, the power mode control unit 44 of the power mode controller 18c executes the ON-control. Thereby, the update control unit 28 executes the activation of the software update device 18a. When the software update device 18a is activated, the process proceeds to step S16.

In step S16, the update control unit 28 causes the display unit 42 of the IVI 36 to display the completion notification for notifying the user that the software update process has been completed. Further, the update control unit 28 uploads the result log to the server device 14. The process of step S16 corresponds to the process of Q10 shown in FIG. 2.

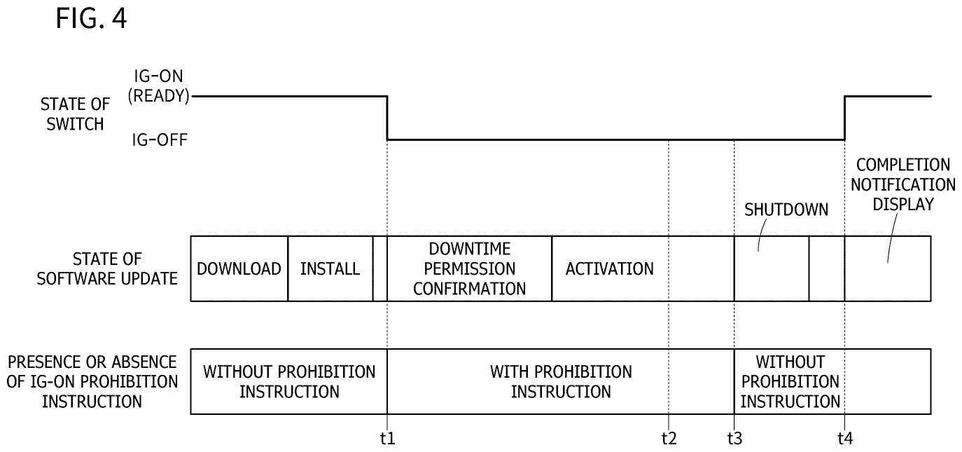

FIG. 4 is a time chart of a software update process. At time t1, the state of the switch 46 is switched from IG-ON (or READY) to IG-OFF by the user (step S3 in FIG. 3: YES). At this point, the update control unit 28 executes the downtime permission confirmation process (step S6 in FIG. 3). Further, the ON-control prohibition unit 30 gives the power mode control unit 44 an ON-control prohibition instruction (step S4 in FIG. 3). When the user permits the downtime (step S7 in FIG. 3: YES), the update control unit 28 starts the activation process.

At time t2 during the activation process, the update control unit 28 executes the restart of the software update device 18a (step S9 in FIG. 3). Even immediately after time t2, the ON-control prohibition unit 30 keeps active the ON-control prohibition instruction for the power mode control unit 44 (step S11 in FIG. 3).

At time t3, the update control unit 28 completes the activation process and executes shutdown of the software update device 18a (steps S12 and S14 in FIG. 3). At this point, the ON-control prohibition unit 30 revokes the prohibition of the ON-control for the power mode control unit 44 (step S13 in FIG. 3). Thus, the ON-control prohibition instruction to the power mode control unit 44 is removed.

At time t4, the state of the switch 46 is switched from IG-OFF to IG-ON (or READY) by the user. In response to the IG-ON, the update control unit 28 causes the display unit 42 of the IVI 36 to display the completion notification (step S16 in FIG. 3).

In this embodiment, the ON-control prohibition unit 30 maintains the prohibited state of the ON-control even after the restart of the software update device 18a, based on the prohibition information stored in the non-volatile memory of the storage unit 22a. According to the present embodiment, the prohibition state of the ON-control (IG-ON) can be maintained until the activation process is completed. That is, the user can switch the state of the switch 46 to IG-ON (or READY) after the activation process is completed. According to the present embodiment, immediately after the user switches the state of the switch 46 to IG-ON (or READY), the completion notification indicating that the software update has been completed can be displayed on the display unit 42 of the IVI 36. In this way, according to the present embodiment, software update can be performed preferably.

### 4 Supplementary Notes

With respect to the above embodiments, the following supplementary notes are further disclosed.

### Supplementary Note 1

A software update system (10) of the present disclosure includes a vehicle (12) and a server device (14) configured to communicate with the vehicle via a network (16) and also includes an update control unit (28) configured to execute a software update process, which is a process for updating software, for an electronic control unit (18) provided in the vehicle, and an ON-control prohibition unit (30) configured to prohibit ON-control, which is control for switching the vehicle from a non-drivable state to a drivable state in response to a user turning on a switch (46), wherein in a state where the electronic control unit provided with the update control unit is the target of the software update process and an activation process of the software update process, is being executed for the electronic control unit provided with the update control unit, the ON-control prohibition unit continues to prohibit the ON-control until the activation process is completed.

According to the above configuration, the prohibition state of the ON-control (IG-ON) can be maintained until the activation process is completed. That is, the user can switch the state of the switch to IG-ON (or READY) after the activation process is completed. According to the above configuration, immediately after the user switches the state of the switch to IG-ON (or READY), a completion notification indicating that the software update has been completed can be displayed on the display unit. Thus, according to the above configuration, the software can be updated favorably.

### Supplementary Note 2

In the software update system described in supplementary note 1, the update control unit may restart, during the activation process, the electronic control unit provided with the update control unit, and the ON-control prohibition unit may continue to prohibit the ON-control until the activation process is completed, even after the restart.

### Supplementary Note 3

In the software update system described in supplementary note 2, prohibition information indicating the prohibition of the ON-control may be stored in a memory (22a) at a stage where the restart is executed, and the ON-control prohibition unit may maintain the prohibition of the ON-control based on the prohibition information stored in the memory.

### Supplementary Note 4

In the software update system described in supplementary note 1, the update control unit may notify the user that the software update process has been completed when the activation process has been completed and the ON-control is executed.

### Supplementary Note 5

A software update device (18a) of the present disclosure includes an update control unit configured to execute a software update process for an electronic control unit provided in a vehicle, and an ON-control prohibition unit configured to prohibit ON-control, which is control for switching the vehicle from a non-drivable state to a drivable state in response to a user's operation of turning on a switch, wherein in a state where the electronic control unit provided with the update control unit is a target of the software update process and an activation process of the software update process is being executed for the electronic control unit provided with the update control unit, the ON-control prohibition unit continues to prohibit the ON-control until the activation process is completed.

### Supplementary Note 6

A software update method of the present disclosure includes an update control step of executing a software update process for an electronic control unit provided in a vehicle, and an ON-control prohibition step of prohibiting ON-control, which is control for switching the vehicle from a non-drivable state to a drivable state in response to a user's operation of turning on a switch, wherein in a state where the electronic control unit that executes the software update process is a target of the software update process and an activation process of the software update process is being executed for the electronic control unit that executes the software update process, the ON-control prohibition step continues to prohibit the ON-control until the activation process is completed.

### Supplementary Note 7

The program of the present disclosure causes a computer to execute the software update method described in supplementary note 6.

Although the present disclosure has been detailed, the present disclosure is not limited to the individual embodiments described above. These embodiments may be variously added, replaced, altered, partially deleted, etc., without departing from the scope of the present disclosure or the intent of the present disclosure as derived from the claims and their equivalents. These embodiments can also be implemented in combination. For example, in the above-described embodiment, the order of the operations and the order of the processes are shown as an example, and are not limited to these. The same applies to the case where numerical values or mathematical expressions are used in the description of the above-described embodiment.

1. A software update system comprising:
a vehicle;
a server device configured to communicate with the vehicle via a network; and
one or more processors that execute computer-executable instructions stored in a memory,
wherein
the one or more processors execute the computer-executable instructions to cause the software update system to:
execute a software update process, which is a process for updating software, for an electronic control unit provided in the vehicle; and
prohibit ON-control, which is control for switching the vehicle from an undrivable state to a drivable state in response to an operation of turning on a switch by a user, and
prohibit the ON control continuously until the activation process is completed, in a state where the electronic control unit that executes the software update process is a target of the software update process and an activation process of the software update process is being executed for the electronic control unit that executes the software update process.

2. The software update system according to claim 1, wherein
the one or more processors execute the computer-executable instructions to cause the software update system to:
restart, during the activation process, the electronic control unit that executes the software update process; and
prohibit the ON control continuously until the activation process is completed, even after the restart.

3. The software update system according to claim 2, wherein
prohibition information indicating prohibition of the ON-control is stored in a memory at a stage where the restart is executed, and
the one or more processors execute the computer-executable instructions to cause the software update system to maintain the prohibition of the ON-control based on the prohibition information stored in the memory.

4. The software update system according to claim 1, wherein
the one or more processors execute the computer-executable instructions to cause the software update system to notify, in a case where the activation process has been completed and the ON-control is executed, the user that the software update process has been completed.

5. A software update system comprising one or more processors that execute computer-executable instructions stored in a memory,
wherein
the one or more processors execute the computer-executable instructions to cause the software update system to:
execute a software update process for an electronic control unit provided in a vehicle;
prohibit ON-control, which is control for switching the vehicle from an undrivable state to a drivable state in response to an operation of turning on a switch by a user; and
prohibit the ON control continuously until the activation process is completed, in a state where the electronic control unit that executes the software update process is a target of the software update process and an activation process of the software update process is being executed for the electronic control unit that executes the software update process.

6. A software update method executed by one or more processors, the method comprising:
executing a software update process for an electronic control unit provided in a vehicle; and
prohibiting ON-control, which is control for switching the vehicle from an undrivable state to a drivable state in response to an operation of turning on a switch by a user,
wherein
the ON-control is continuously prohibited in the prohibiting of the ON-control until an activation process is completed, in a state where the electronic control unit that executes the software update process is a target of the software update process and an activation process of the software update process is being executed for the electronic control unit that executes the software update process.

7. A non-transitory storage medium storing a program for causing a computer to execute the software update method according to claim 6.
